(19) United States
(12) Patent Application Publication
(10) Pub. No.: US 2011/0003213 A1
(43) Pub. Date: Jan. 6, 2011

(54) METAL-AIR BATTERY WITH SILOXANE MATERIAL

(75) Inventors: Trygve Burchardt, Mannedorf (CH); Zsófia Al Gorani-Szigeti, Kloten (CH); Kathrin Vuille dit Bille, Zurich (CH)

Correspondence Address: FOLEY & LARDNER LLP, 777 EAST WISCONSIN AVENUE, MILWAUKEE, WI, 53202-5306, US

(73) Assignee: ReVolt Technology Ltd.

(21) Appl. No.: 12/828,016

(22) Filed: Jun. 30, 2010

Related U.S. Application Data
(63) Continuation-in-part of application No. 12/826,383, filed on Jun. 29, 2010.
Application No. 12/826,383 is a continuation-in-part of application No. PCT/US10/40445, filed on Jun. 29, 2010.
(60) Provisional application No. 61/230,550, filed on Jul. 31, 2009.
(60) Provisional application No. 61/221,998, filed on Jun. 30, 2009.
(60) Provisional application No. 61/340,293, filed on Mar. 15, 2010.
(60) Provisional application No. 61/221,998, filed on Jun. 30, 2009.
(60) Provisional application No. 61/340,293, filed on Mar. 15, 2010.

(51) Int. Cl. H01M 8/22

(52) U.S. Cl. 429/402

(57) ABSTRACT

A metal-air battery includes an air electrode and a siloxane material proximate to or incorporated within the air electrode. A method is also disclosed that includes providing a siloxane material, providing a transfer layer, and co-extruding the siloxane material with the transfer layer to form a siloxane membrane. The siloxane membrane may be used in a metal-air battery.

### CROSS-REFERENCE TO RELATED PATENT APPLICATIONS

The present application claims priority to and the benefit of U.S. Provisional Patent Application No. 61/230,550, filed Jul. 31, 2009. The present application is also a Continuation-in-Part of U.S. patent application Ser. No. 12/826,383, filed Jun. 29, 2010, and International Application PCT/US10/40445, filed Jun. 29, 2010, each of which claim priority to and the benefit of U.S. Provisional Patent Application No. 61/221,998, filed Jun. 30, 2009, and U.S. Patent Application No. 61/340,293, filed Ma. 15, 2010. The disclosures of each of the applications mentioned in this paragraph are incorporated herein by reference in their entireties.

### BACKGROUND

The present application relates generally to the field of batteries and components of batteries. More specifically, the present application relates to the use of processes, materials, and structures/components to manage the interaction between the internal chemical reaction in a metal-air battery and the external environment. The concepts disclosed herein are further applicable to metal-air fuel cells.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the anode and the cathode.

During discharging of the metal-air batteries, oxygen from the atmosphere is converted to hydroxyl ions in the air electrode. The reaction in the air electrode involves the reduction of oxygen, the consumption of electrons, and the production of hydroxyl ions. The hydroxyl ions migrate through the electrolyte toward the metal negative electrode, where oxidation of the metal of the negative electrode occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

A metal-air battery is a partially open system, in which the air electrode utilizes oxygen from the surrounding environment. One challenge associated with such an open system is that environmental conditions such as humidity and the presence of carbon dioxide (CO₂) may impact the battery, and in some cases may significantly shorten the lifespan of the battery. This in turn may limit the possible applications in which conventional metal-air batteries may be used.

It has been observed that relatively low humidity in the surrounding environment (e.g., less than 45 percent relative humidity) may cause undesirable drying out of the electrolyte. Drying out of the metal-air battery causes an increase in ohmic resistance, and, subsequently, a loss in the power density and efficiency of the battery. Further, with relatively long term exposure in dry environments, the electrolyte can dry out completely, causing irreversible battery failure.

It has further been observed that when the humidity in the surrounding environment is relatively high (e.g., greater than 45 percent relative humidity), the electrode may flood. For example, where the humidity is relatively high, moisture will be taken into the metal-air battery, causing a fall in electrolyte concentration and an increase in volume. The discharge performance of the metal-air battery will consequently be reduced and leakage of the electrolyte may occur.

The presence of CO₂ has been reported to adversely affect the performance and lifetime of metal-air batteries. It has been suggested that CO₂ may cause the pore structure of the air electrode to close up and that CO₂ may also cause a loss of conductivity (e.g., by displacing OH⁻ (hydroxide) ions with CO₃²⁻). Although CO₂ may enter a metal-air battery from the external environment, it has also been suggested that CO₂ may be generated internally by the metal-air battery itself (e.g., through oxidation of the carbon support).

In order to address issues associated with undesirable environmental conditions for metal-air batteries and fuel cells, others have suggested the use of peripheral systems (e.g., fans, valves, humidifiers, CO₂ scrubbers, etc.) to control the impact that the external environment may have. Obvious shortcomings of such solutions include increased cost and complexity of the system, increased size (thus giving a lower effective energy density), and the fact that such solutions may not be suitable for use in certain applications (e.g., one would not want to use an external fan for a hearing aid battery).

It would be advantageous to provide an improved battery and structures/features therefor that address one or more of the foregoing issues. It would also be advantageous to provide materials and structures in a metal-air battery that provide for management of the interaction between the internal chemical reaction in the battery and the external environment. It would also be advantageous to provide a metal-air battery having a longer lifespan. It would also be advantageous to provide a metal-air battery that may be used in a variety of applications, including, but not limited to, large scale and small scale applications. Other advantageous features of the battery disclosed herein will be apparent to those reviewing the present disclosure.

### SUMMARY

An exemplary embodiment relates to a metal air battery that comprises an air electrode and a siloxane material proximate to or incorporated within the air electrode.

Another exemplary embodiment relates to a metal-air battery that comprises a metal electrode; an electrolyte; an air electrode; a siloxane membrane proximate to or incorporated within the air electrode; and a housing.

Another exemplary embodiment relates to a metal-air battery that comprises a siloxane material configured to reduce the transport of carbon dioxide therethrough.

### BRIEF DESCRIPTION OF THE DRAWINGS

FIG. 1 is a perspective view of a metal-air battery in the form of a button cell according to an exemplary embodiment.

FIG. 2 is a cross-sectional view of the metal-air battery shown in FIG. 1 taken along a line 2-2.

FIG. 3 is a cross-sectional view of a metal-air battery similar to that shown in FIG. 1

FIG. 4 is a cross-sectional view of a metal-air battery similar to that shown in FIG. 1.

FIG. 5 is a cross-sectional view of a metal-air battery similar to that shown in FIG. 1.

FIG. 6 is a perspective view of a metal-air battery in the form of a prismatic cell according to another exemplary embodiment.

FIG. 7 is a cross-sectional view of the metal-air battery shown in FIG. 6 taken along line 7-7.

FIG. 8 is a detail view of the cross-section of the metal-air battery shown in FIG. 7 taken along a line 8-8.

FIG. 9 is a partially exploded perspective view of a flow battery according to an exemplary embodiment.

FIGS. 10-18 are graphs illustrating the results from a number of experiments as described herein, and are intended to show the benefits of using an oxygen-selective material such as siloxane in a metal-air battery.

### DETAILED DESCRIPTION

According to an exemplary embodiment, a metal-air battery or cell is provided that exhibits improved stability and performance when exposed to water vapor (e.g., the relative humidity) and other component elements of its surrounding environment (e.g., CO₂). The metal-air battery is configured to substantially retain water when the surrounding environment has low humidity, to resist flooding when the surrounding environment has high humidity, and to transition effectively between low and high humidity environments without substantially sacrificing these benefits. The metal-air battery is also configured to reduce undesirable effects that may result from exposure to CO₂. According to an exemplary embodiment, one or more materials and structures/components may be incorporated into a metal-air battery to provide an improved lifespan without compromising high current density for the battery, enabling the battery to be used for a wide range of applications.

The metal-air battery may have any desired configuration, including, but not limited to coin or button cells, prismatic cells, cylindrical cells, oval cells, flow cells, etc., or may have a fuel cell configuration. Further, the metal-air battery may be a primary (disposable, single-use) or a secondary (rechargeable) battery.

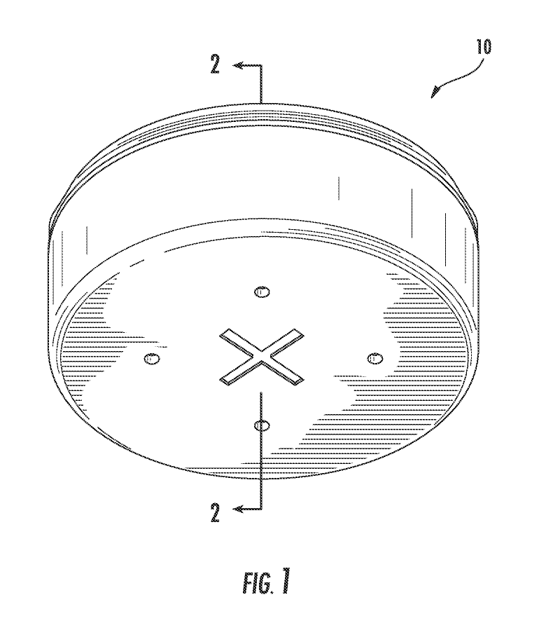

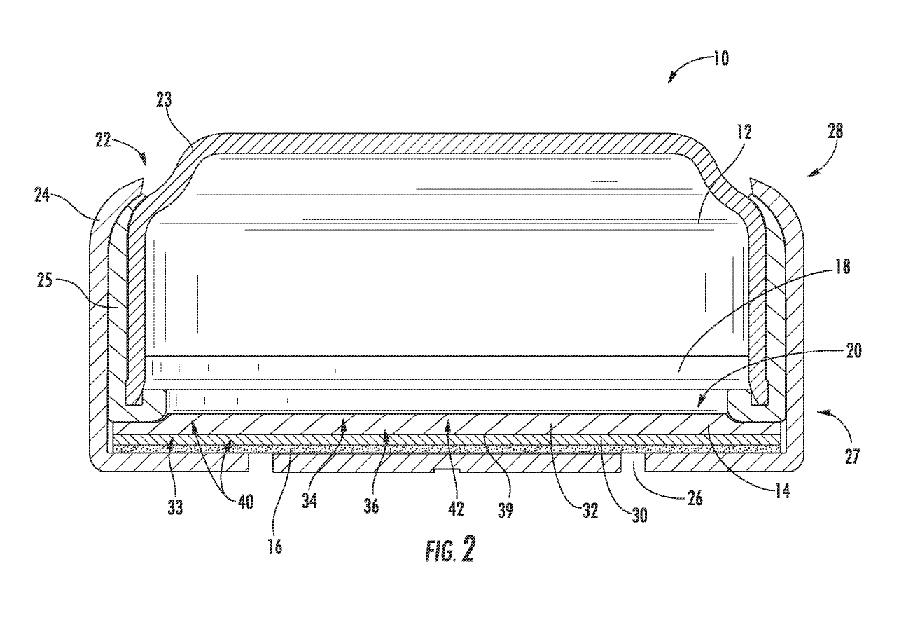

Referring to FIGS. 1-2, a metal-air battery 10 shown in the form of a coin or button cell is illustrated according to an exemplary embodiment. The battery 10 includes a metal electrode 12, an air electrode 14, an oxygen-selective membrane in the form of a siloxane membrane 16 (hereinafter referred to as the “siloxane membrane”), an electrolyte 18, a separator 20, and an enclosing structure shown as a housing 22 according to an exemplary embodiment.

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “ABₓ” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown as including a base 23 and a lid 24 according to an exemplary embodiment. A seal 25 (e.g., a molded nylon sealing gasket, etc.) is formed or disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 (e.g., apertures, openings, slots, recesses, etc.) at a first portion 27 of the housing 22 generally opposite a second portion 28. The metal electrode 12 is shown disposed within the housing 22 at or proximate to the second portion 28. The air electrode 14 is shown disposed at or proximate to the first portion 27, and is spaced a distance from the metal electrode 12. The holes 26 provide for interaction between the air electrode 14 and the oxygen in the surrounding atmosphere (e.g., air). The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The separator 20 is a thin, porous, film or membrane (e.g., a plastic film, an ion selective membrane, etc.) disposed substantially between the metal electrode 12 and the air electrode 14 according to an exemplary embodiment. The separator 20 is configured to prevent the short circuiting of the battery 10 by providing electrical isolation between the metal electrode 12 and the air electrode 14. In some exemplary embodiments, the separator 20 includes or is made of polypropylene or polyethylene that has been treated to develop hydrophilic pores that are configured to fill with the electrolyte 18. In other exemplary embodiments, the separator may be made of any material that is suited for preventing short circuiting of the battery 10 and/or that includes hydrophilic pores.

The electrolyte 18 is shown disposed substantially between the metal electrode 12 and the air electrode 14 according to an exemplary embodiment. The electrolyte 18 (e.g., potassium hydroxide (“KOH”) or other hydroxyl ion-conducting media) is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge. The electrolyte 18 is disposed within some of the pores of the metal electrode 12 and some of the pores of the air electrode 14. According to one exemplary embodiment, the electrolyte may be partially absorbed into the air electrode to provide for a three-phase zone with a high surface area for the air electrode catalyst(s). The electrolyte may further be evenly distributed within the metal electrode, helping prevent uneven current distribution in the metal electric load as the reaction moves from the surface of the zinc electrode therethrough. According to other exemplary embodiments, the distribution and location of the electrolyte may vary. According to some exemplary embodiments, the composition of the electrolyte may help prevent and or manage CO₂ production within the cell.

According to an exemplary embodiment, the electrolyte 18 is an alkaline electrolyte used to maintain high ionic conductivity between the metal electrode and the air electrode. According to some exemplary embodiments, the electrolyte may be any electrolyte that has high ionic conductivity and/or high reaction rates for the oxygen reduction/evolution and the metal oxidation/reduction reactions (e.g., NaOH, LiOH, KOH, etc.). According to other embodiments, the electrolyte may include salt water or others salt-based solutions that give sufficient conductivity for the targeted applications (e.g., for marine/military applications, etc.). According to still other exemplary embodiments, the electrolyte may be organic-based, water-based, or a combination of organic-based and water-based.

According to an exemplary embodiment, the metal electrode and the electrolyte are combined (e.g., mixed, stirred, etc.). The combination of the metal electrode and the electrolyte may form a paste, powder, pellets, slurry, etc.

The air electrode 14 includes one or more layers with different properties and a current collector (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the gas diffusion layer 30. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. For example, gas selective materials may be included in the pore structure.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

Referring further to FIG. 2, a current collector 39 is disposed between the gas diffusion layer 30 and the active layer 32 of the air electrode 14 according to an exemplary embodiment. In the exemplary embodiment shown, the placement of the current collector 39 facilitates assembly of the siloxane membrane 16 and the air electrode 14. According to another exemplary embodiment, the current collector may be disposed on the active layer (e.g., when a non-conductive layer or no gas diffusion layer is included in the air electrode). The current collector 39 may be formed of any suitable electrically-conductive material.

The air electrode 14 further includes a binding agent or combination of binding agents 40, a catalyst or a combination of catalysts 42, and/or other additives (e.g., ceramic materials, high surface area metals or alloys stable in alkaline media, etc.). According to an exemplary embodiment, the binding agents 40 are included in both the active layer 32 and the gas diffusion layer 30, and the catalysts 42 are included in the active layer. According to other exemplary embodiments, the binding agents, catalysts, and/or other additives may be included in any, none, or all of the layers of the air electrode. In other exemplary embodiments, the air electrode may not contain one or more of a binding agent or combinations of binding agents, a catalyst or a combination of catalysts, and/or other additives.

The binding agents 40 are intended to provide increased mechanical strength for the air electrode 14, while providing for maintenance of relatively high diffusion rates of oxygen (e.g., comparable to more traditional air electrodes that typically use polytetrafluoroethylene (“PTFE”)). The binding agents 40 may also cause pores in the air electrode 14 to become hydrophobic. According to one exemplary embodiment, the binders include PTFE in combination with other binders. According to other exemplary embodiments, other polymeric materials may also be used (e.g., thermoplastics such as polybutylene terephthalate or polyamides, polyvinylidene fluoride, silicone-based elastomers such as polydimethylsiloxane, or rubber materials such as ethylene propylene, and/or combinations thereof).

According to an exemplary embodiment, the binding agents 40 provide mechanical strength sufficient to allow the air electrode 14 to be formed in a number of manners, including, but not limited to, one or a combination of extrusion, stamping, pressing, utilizing hot plates, calendering, etc. This improved mechanical strength also enables air electrode 14 to be formed into any of a variety of shapes (e.g., a tubular shape, etc.). The ability to form the air electrode into any of a variety of shapes may assist in the manufacture of metal-air batteries for applications such as Bluetooth headsets, applications for which tubular batteries are used or required (e.g., size AA batteries, size AAA batteries, size D batteries), etc.

The catalysts 42 are configured to improve the reaction rate of the oxygen reaction. According to some exemplary embodiments, catalytically active metals or oxygen-containing metal salts are used (e.g., Pt, Pd, Ag, Co, Fe, MnO₂, KMnO₄, MnSO₄, SnO₂, Fe₂O₃, CoO, Co₃O₄, etc.). According to other exemplary embodiments, a combination of more than one catalytically active material may be used.

In an exemplary embodiment, the battery 10 is a secondary battery (e.g., rechargeable) and the air electrode 14 is a bifunctional air electrode. In this exemplary embodiment, additional catalysts or catalyst combinations capable of evolving oxygen may be used in addition to the catalysts and/or combinations of catalysts described above. According to some exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, the battery 10 may be a primary battery (e.g., single use, disposable, etc.).

According to an exemplary embodiment, the air electrode 14 is formed in a three-step process. Each layer of the multi-layer air electrode 14 is formed separately. First, the desired component elements of each layer are mixed together. The pore forming materials, the catalysts, the binding materials and/or other additives are mixed under the influence of mechanical, thermal, or mechanical and thermal energy. In this process it is desirable that the materials be well distributed. If the mixture contains a hydrophobic binding agent, then this binding agent forms a three dimensional network connecting the powders into an agglomerate. The mixture or the agglomerate is then typically extruded and/or calendered into a layer. Secondly, one or more layers, typically having differing properties (e.g., the gas diffusion layer and the active layer), are combined using heat and/or pressure (e.g., by calendering and/or pressing). Third, the current collector is pressed or calendered into the combined layers (e.g., into the active layer, into the gas diffusion layer, between the active layer and the gas diffusion layer, etc.). According to other embodiments, however, the air electrode may be formed using other processes.

According to an exemplary embodiment, a dry mixing process is utilized in the first step to form the layers of air electrode 14. In a dry mixing process, all of the ingredients of a layer are mixed together in the form of dry powders. According to an exemplary embodiment, a dry process utilizes PTFE binders having a particle size below 1 mm as a binder and an additional pore forming aid such as ammonium bicarbonate to create the gas diffusion layer and/or the oxygen evolution layer.

According to other exemplary embodiments, a wet mixing process may instead be utilized. In a wet mixing process, one or more solvents are added at the beginning or during the mixing process, or, alternatively, one or more ingredients may be used in the form of a dispersion or suspension. The solvent(s) are typically subsequently removed (e.g., directly after the mixing process or in a later state of the production process) (e.g., by using a heating/drying process). According to an exemplary embodiment, a wet process utilizes PTFE that is suspended in water as a binder and a pore forming aid such as ammonium bicarbonate to create the oxygen evolution layer.

According to still another exemplary embodiment, the various individual layers may be made using different methods. For example, some of the layers may be produced using a dry mixing process, while others may be produced using a wet process. According to yet still another exemplary embodiment, it is possible to combine both dry and wet processes for the different layers and the production may be performed in a continuous production line according to PCT publication WO 2005/004260, the disclosure of which is hereby incorporated by reference.

An oxygen evolution layer may be included in the air electrode. According to an exemplary embodiment, the oxygen evolution layer may includes 2 to 15 percent binding agent by weight and 25 to 65 percent catalyst(s) by weight. The remainder of the oxygen evolution layer may include a high surface area carbon and/or graphite material and possibly some other additives.

An exemplary embodiment of an air electrode formation method utilizing a dry mixing process will now be discussed. According to this method, the active layer is prepared using a mixture of 15 percent PTFE by weight (e.g., in powder form with a particle size below 1 mm from Lawrence Industries of Thomasville, N.C. as a binding agent), 70 percent high surface area carbon (e.g., XC 500 from Cabot) by weight as a pore forming agent, and 15 percent manganese sulfate (e.g., MnSO₄ from Prolabo of France) by weight as a catalyst. The binding agent, the pore forming agent, and the catalyst are mixed together (e.g., in a single-shaft rotary mixer at approximately 1,000 rpm) to form a substantially homogeneous mixture. The mixture is heated to a desired temperature. When the powder mixture reaches the desired temperature, the powder is milled to form an agglomerate. For example, the mixture may be heated to a desired temperature at or near 90° C. and milled at approximately 1,000 rpm for 1 hour, or the mixture may be heated to a lower initial temperature, but milled at a higher rpm (e.g., 10,000 rpm). The agglomerate is pressed into a brick (e.g., a brick of about 2 mm thickness) and then calendered into a sheet (e.g., of about 0.5 mm thickness). According to other exemplary embodiments, the temperatures, milling rates and times, and other parameters may vary depending on the particular materials used and other factors.

The gas diffusion layer is formed using a mixture of 25 percent PTFE by weight (e.g., in powder form with a particle size below 1 mm from Lawrence Industries of Thomasville, N.C.) as a binding agent and 75 percent ammonium bicarbonate by weight (e.g., with a particle size below 10 μm from Sigma-Aldrich, Inc.) as a pore forming agent. The binding agent and the pore forming agent are mixed at a desired temperature (e.g., typically below a maximum temperature of 40° C.) in a single-shaft rotary mixer (e.g., for 2 hours at 1,500 rpm) to form an agglomerate. The agglomerate is pressed into a brick (e.g., of about 2 mm thickness) and then calendered into a sheet (e.g., of about 1 mm thickness).

An exemplary embodiment of an air electrode formation method utilizing a wet mixing process will now be discussed. According to this method, the active layer is prepared using 15 percent PTFE by weight in a suspension containing 60 percent PTFE by weight dispersed in water (e.g., from Sigma-Aldrich, Inc.) as a binding agent, 65 percent high surface area carbon (e.g., XC 500 from Cabot) by weight as a pore forming agent, and 20 percent manganese sulfate (e.g., MnSO₄ from Prolabo of France) by weight as catalysts. The high surface area carbon is mixed with both catalysts in water. Separately, the PTFE suspension is mixed with water. The PTFE suspension is then added to the carbon suspension and mixed to form a slurry agglomerate. The slurry is then mixed (e.g., in an ultrasonic bath for 30 minutes) and subsequently dried (e.g., at 300° C. for 3 hours) to remove any surfactants. The dried mixture is then agglomerated and a hydrogen treated naphtha with a low boiling point (e.g., Shellsol D40 from Shell Chemicals of London) is added to form a paste. Finally, the paste is calendered into a thin layer to form the active layer.

The hydrophobic gas diffusion layer may be formed by the same method according to an exemplary embodiment. In this layer only high surface area carbon (65 percent by weight) and PTFE (35 percent by weight) are used. The final layer is relatively thin (e.g., having a thickness of about 0.8 mm).

The active layer and the gas diffusion layer are then coupled (e.g., by calendering) to form the air electrode (e.g., having a total thickness of 0.8 mm). Finally, a current collector (e.g., nickel mesh) is pressed into the air electrode (e.g., at 70 bars and at a temperature of between approximately 80° C. and 320° C., and preferably approximately 300° C.) between the active layer and the gas diffusion layer. The air electrode may then be dried (e.g., at 70° C. for 8 hours) to create the hydrophobic porosity of the gas diffusion layer and to remove the ammonium bicarbonate therefrom.

According to other exemplary methods of forming and constructing an air electrode and the layers thereof, the layers may be formed to have a variety of thickness and/or compositions. Further, the layers may be coupled by any of a number of methods known in the art.

Referring back to FIG. 2, according to an exemplary embodiment, a membrane shown as a siloxane membrane 16 (e.g., film, layer, etc.) is disposed adjacent to the air electrode 14 (i.e., located substantially adjacent to the gas diffusion layer 30 of the air electrode 14 between the gas diffusion layer 30 and the holes 26 in the housing 22). The siloxane membrane is 16 is a selective membrane that allow gases such as oxygen to pass through the membrane while acting as a moisture barrier to prevent moisture from entering and exiting the battery. This in turn helps to maintain the water balance within the battery 10.

The siloxane membrane 16 is configured to improve the performance and usable lifetime of the battery 10 by preventing or slowing down the drying out of the electrolyte and the flooding of the air electrode. The siloxane membrane 16 is configured to prevent water from the electrolyte 18 from leaving the battery 10 (e.g., when the relative humidity less than 45 percent relative humidity or some other relative humidity that would result in water loss), thus helping to avoid the loss in the power density and efficiency of the battery that occurs when electrolyte dries out. The siloxane membrane 16 is also configured to prevent flooding of the battery 10 (e.g., when the relative humidity is greater than 45 percent or some other relative humidity that would result in flooding), helping to prevent the electrolyte 18 from leaking therefrom (when the electrolyte leaks from the battery, the electrolyte concentration (the ratio between electrolyte and Zn) falls, resulting in significant decreases in the discharge performance and the ability to store metal-air batteries long-term. In this manner, the siloxane membrane 16 helps stabilize, improve the performance of, and prolong the lifetime of the battery 10, significantly expanding the potential commercial uses of metal-air batteries.

The siloxane membrane 16 is also configured to prevent ingress of CO₂ through the holes 26 in the housing. It is known that CO₂ consumes OH⁻ ions in electrolyte, increases the evaporation of water, and forms non-hygroscopic crystals. By preventing CO₂ from entering the housing 22, the siloxane membrane 16 helps preserve the electrolyte 18 and maintain the water balance within the battery 10.

The siloxane membrane 16 has a thickness of between approximately 0.1 μm and 200 μm (although the thickness may be greater according to other exemplary embodiments, for example, the thickness of the membrane may be between 1 and 50 μm, less than or equal to 10 μm, less than or equal to 6 μm, less than or equal to 3 μm, or any other suitable thickness as may be appropriate under the circumstances), and has suitable mechanical strength to allow its production using a wide range of manufacturing methods. The greater the thickness of the siloxane membrane, the better it will be expected to perform in preventing CO₂ and water vapor from being transported into and/or out of battery 10 (e.g., because of the longer diffusion path). The thickness of siloxane membrane 16 may be varied depending on the intended application for the battery, since the thickness of an applied membrane/film is expected to be directly proportional to the current density that can be achieved for a battery. For example, for applications using a relatively low current density (e.g., lower power applications such as batteries for watches, sensors, RFID tags, etc.), films with relatively greater thicknesses may be used (e.g., a 100 μm film that provides a maximum current density of 2 mA/cm²). In other applications where high current density is required (e.g., high power applications such as cameras, blue tooth applications, cellular phones, etc.), it may be desirable to use a siloxane film of lesser thickness (e.g., a 3 μm film that can provide a maximum current density of more than 50 mA/cm² at above 1 V).

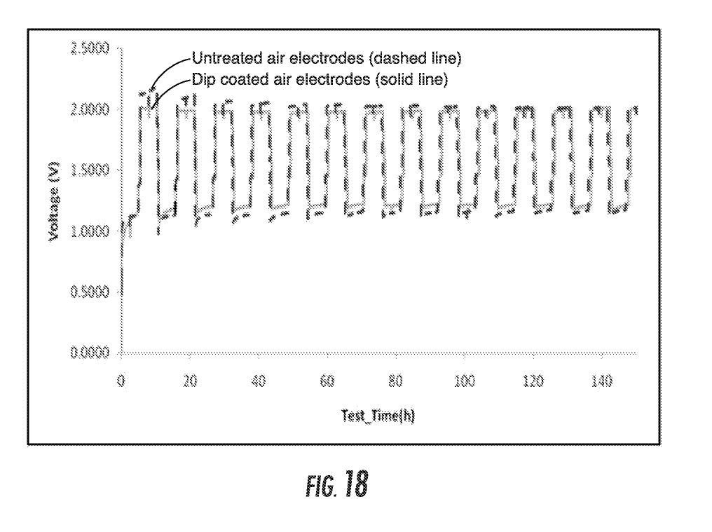

Different applications have different current density needs, and, accordingly, the thickness of the selective membrane may be tailored to achieve a desired current density. This will be described in more detail below with respect to FIG. 17. According to other exemplary embodiments, any selective membrane material having a thickness/diffusion coefficient combination sufficient to both stabilize a metal-air battery while maintaining a desired performance level may be utilized.

According to an exemplary embodiment, increasing the surface area of the air electrode may allow for the use of thicker siloxane films that still allow the battery to achieve a desired current density. Generally, a larger surface area allows for a higher reaction rate, since the current density (mA/cm²) is determined by the thickness of the siloxane film, while the current (mA) is determined by the current density and the surface area of the air electrode available for the application. These considerations may be balanced by a battery designer attempting to achieve a certain level of battery performance while taking advantage of the enhancements that the use of a selective siloxane membrane can provide for the battery.

The siloxane membrane 16 also allows for the use of larger and/or more holes 26 in the housing 22 for oxygen access than would otherwise be possible (e.g., more air may be allowed to enter the battery when the siloxane membrane 16 is used because of its beneficial protections against dry out and flooding). This allows the battery 10 to operate at higher currents without oxygen diffusion limitations and increased dry out rates. As an example, a primary coin cell (e.g., size 675) zinc-air battery may show diffusion limitation at about 30 mA due to the limited oxygen access. Providing a hole of more than 5 mm in diameter gives a pulse current of more than 100 mA without diffusion limitations. Further, this enables greater flexibility in the design of housing 22 (e.g., casing, containers, etc.) and better uniformity of the oxygen distribution (with even partial pressure of O₂ over the whole surface, the reaction rate is equal, and a more uniform reaction gives better stability for the Zn and air electrode). By allowing for larger and/or more holes in the housing, the current density of the battery is not limited by the access of oxygen through the holes, but, rather, by the transport of oxygen through the selective membrane. With the selective membranes having high transport properties for oxygen, this also opens the possibility to use metal-air batteries for higher power applications (e.g., laptops, cars, etc.).

According to an exemplary embodiment, the siloxane membrane 16 does not include a support layer (e.g., a finely porous film, a non-woven fabric, etc.), because the thickness of the siloxane membrane 16 itself provides sufficient stability and structural integrity for the given application. This also provides for improved handling during manufacture of the batteries and resistance against the formation of pin holes. For thinner siloxane membranes (e.g., membranes having a thickness below approximately 20 μm), there may be some advantage to using a support layer.

The improved mechanical strength of the siloxane membrane also provides for a wide range of formation and application methods. The siloxane membrane formation process may include stamping, pressing, and/or other processes or combinations of processes that would not be able to be utilized or be utilized as well with thinner and/or weaker films or membranes, as will be discussed in more detail below. Further, the improved formation and applications methods enable the battery 10 to be used in a wider range of applications.

According to an exemplary embodiment, the siloxane membrane 16 is formed using siloxane Geniomer® 80 from Wacker Chemie AG of Münich, Germany. Geniomer® 80 is a reaction product of silicone resin with silicone fluids, which forms water-repellent release films. These films have much better affinity than is attainable with polydimethylsiloxanes and many organomodified silicone fluids of comparable viscosity. For Geniomer® 80, the oxygen diffusion coefficient for a 10 μm thick film is approximately 6.2E-11 m²/s. According to other exemplary embodiments, other siloxane materials may be used (e.g., siloxane from Folex Imaging, Celfa AG, CM Celfa Membranes, etc.). For example, the oxygen diffusion coefficient for a 20 μm thick film made with the siloxane from Celfa is approximately 5.7E-11 m²/s.

Although one particular embodiment of a battery using a siloxane membrane has been described thus far, according to other exemplary embodiments, modifications may be made to the composition and/or positioning of the siloxane membrane. For example, according to one exemplary embodiment, the siloxane membrane may be made conductive for use on top of the gas diffusion layer. According to one exemplary embodiment, materials (e.g., in the form of particles) may be added to the siloxane membrane to enable the siloxane membrane to function as the current collector for the battery cathode. Exemplary materials include, but are not limited to, carbon (e.g., graphite) particles and metallic particles. According to an exemplary embodiment, a siloxane membrane may be made conductive by dip coating the gas diffusion layer into a siloxane solution. A siloxane film is then created within the pore structure of the gas diffusion layer at the same time as the conductive support material (carbon) allows for electronic contact with the current collector.

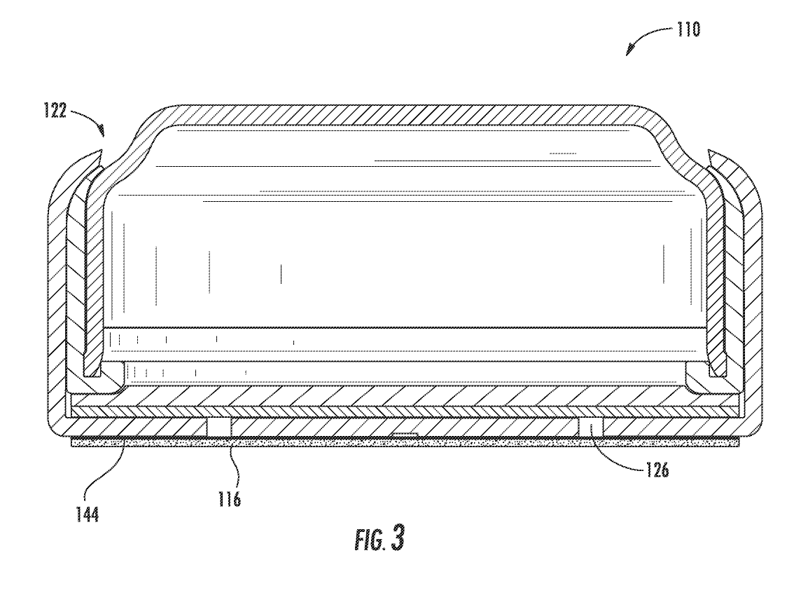

According to another exemplary embodiment, the siloxane membrane may be positioned outside of the housing instead of within the housing as shown in FIG. 2. FIG. 3 illustrates an exemplary embodiment of a metal-air battery 110 including a siloxane membrane 116 positioned outside of the housing 122. The siloxane membrane 116 is shown disposed on a porous support film 144 and positioned substantially over the holes 126 that are included in the housing 122. This configuration may be particularly desirable, for example, if the battery 110 is placed in a housing that has a larger surface area than the battery case. According to another exemplary embodiment, a porous support material (e.g., made of a polymer such as PTFE) may be coated with siloxane (which may fill in some of the pores of the support material) and positioned over the holes. According to some exemplary embodiments, a porous support material including a siloxane additive may be positioned over the holes. It should be noted that, when the siloxane membrane is disposed outside of the housing, the conductivity of the siloxane membrane is substantially irrelevant because there is substantially no need to transport electrons.

According to another exemplary embodiment, the siloxane membrane may be integrated with the housing. For example, a battery having a housing in the form of a soft pouch could incorporate siloxane into the pouch material. In another exemplary embodiment, the siloxane membrane may be provided proximate to or within the air electrode.

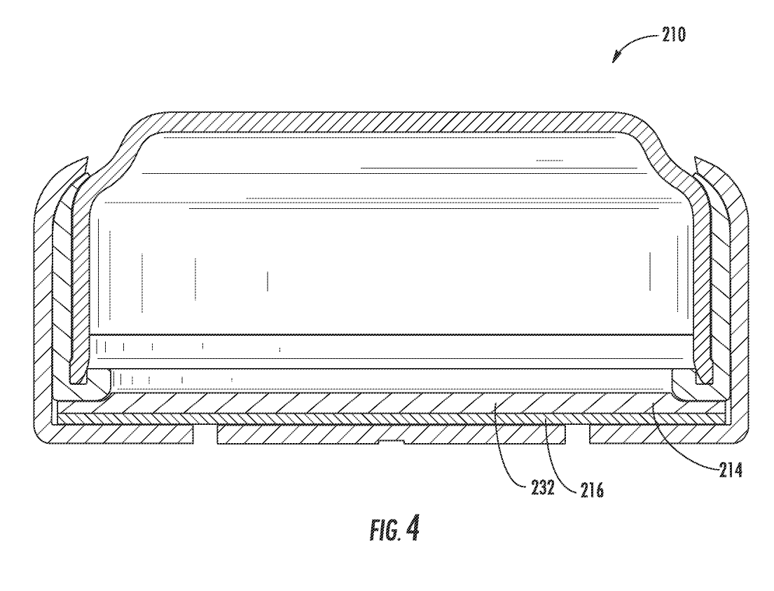

According to another exemplary embodiment, the siloxane membrane may take the place of or act as the gas diffusion layer. For example, FIG. 4 illustrates another exemplary embodiment of a metal-air flow battery 210 including an air electrode 214 and a siloxane membrane 216. The air electrode 214 includes an active layer 232 without an associated gas diffusion layer. Instead, the siloxane layer 216 is shown as being disposed adjacent to the active layer 232. This configuration provides a number of advantages, including, but not limited to, providing enhanced long lifetime stability and safety against leakage because the siloxane layer 216 is substantially a solid membrane that will not allow liquid penetration and is also selective to oxygen to prevent CO₂ from entering the cell.

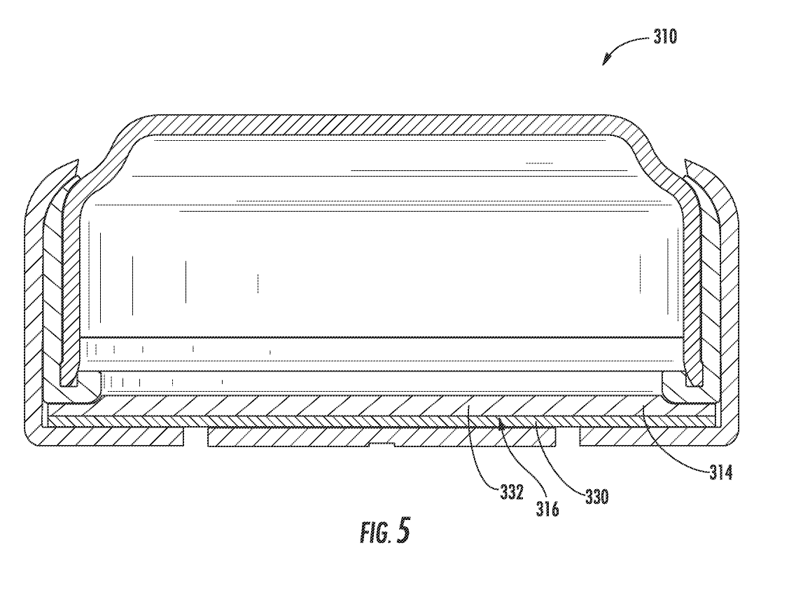

According to another exemplary embodiment, siloxane may be mixed with the materials of the gas diffusion layer to form a single conductive siloxane membrane layer. For example, FIG. 5 illustrates another exemplary embodiment of a metal-air flow battery 310 that includes a siloxane material 316 and an air electrode 314. The air electrode 314 is shown including an active layer 332 and a gas diffusion layer 330. The siloxane material 316 is included in the gas diffusion layer 330. According to one exemplary embodiment, the siloxane material is mixed with the other gas diffusion layer materials and then formed into the gas diffusion layer.

According to an exemplary embodiment, multiple metal electrodes and air electrodes may be provided in a single metal-air battery. Further, while the siloxane membrane and the air electrode are discussed independently for the purposes of this disclosure, it should be recognized that the siloxane membrane may be considered to be a layer of the air electrode.

According to an exemplary embodiment, the siloxane membrane 16 may be used in combination with additional layers (e.g., one or more layers of porous plastic materials, one or more metal layers, etc.) to achieve a desired selectivity for oxygen, water vapor management, and carbon-dioxide management for battery 10. For example, by forming thin (submicron to nanometer) solid nonporous silver layers on the siloxane (e.g., using vapor deposition or similar techniques), the selectivity for O₂ transport while preventing water vapor and CO₂ passage may be improved. Since the rate of transport of oxygen is slow through silver, this additional layer needs to be very thin and will therefore require a support material for deposition. Siloxane can act as this support material, and also advantageously has high oxygen transport properties.

Exemplary methods of manufacturing the siloxane membrane 16 will now be discussed. Considerations in the siloxane membrane manufacturing process include, among others, the ability to ensure an even thickness of the siloxane membrane with low tolerances, the ability to precisely control the siloxane membrane thickness, the ability to ensure that the siloxane membrane is substantially pinhole free, the ability to handle the siloxane membrane in mass manufacturing without damaging it, and the ability to assemble the siloxane membrane and the metal-air battery.

According to an exemplary embodiment that addresses the above-mentioned considerations, the siloxane membrane 16 from Wacker (Geniomer® 80) is co-extruded with a low density polyethylene (LDPE) transfer layer into a two-layer co-extruded film (e.g., membrane, sheet, etc.). According to one exemplary embodiment, the siloxane membrane is a 10 μm Geniomer® 80 film at least partially covering (e.g., disposed on top of, etc.) a 60 μm LDPE film, making the total thickness of the co-extruded film 70 μm. More generally, siloxane membranes having a wide range of thicknesses can be obtained by this method (e.g., a combined thickness of less than 50 μm, a combined thickness of more than 50 μm, etc.).

The co-extrusion process helps to ensure an even thickness of the siloxane membrane and/or the other extruded layers. The co-extrusion process also allows one or more of these layers to be relatively easily delaminated, so that the siloxane membrane layer is removable and can be assembled to the air electrode.

The film is subsequently checked for homogeneity and to ensure that relatively few to no pores are present therein (e.g., by measuring the air permeability). Process parameters such as temperature, pressure, thickness, extrusion speed, and feed screw type may be controlled to help ensure the homogeneity of the siloxane membrane and to help ensure that relatively few to no pores are present in the siloxane membrane.

The co-extruded film is placed onto the gas diffusion layer side of the air electrode, so that the siloxane membrane 16 is facing the air electrode 14. A rand (e.g., 5 mm) for the glue used in the assembly of battery 10 is left uncoated by siloxane membrane 16. The air electrode 14 and the co-extruded siloxane membrane are then calendered to adhere to one another (e.g., between 2 silicon papers and 2 cellulose papers in a 2-step calendering process two step to a combined thickness of 1.62 cm). The upper LDPE transfer layer is then removed, leaving the air electrode with the siloxane membrane at least partially covering its gas diffusion layer side.

Similar to the exemplary method of manufacture described above, according to an exemplary embodiment, the siloxane membrane is co-extruded onto a backing or transfer layer (e.g., plastics such as LDPE, etc.). The transfer layer provides for improved handling of the siloxane membrane and reduces the risk of pinholes and cracks in the siloxane membrane during assembly with the air electrode. The co-extruded layer including both the siloxane membrane and the transfer layer is placed onto the air electrode with the siloxane membrane facing the gas diffusion layer. The co-extruded siloxane membrane and the air electrode are then adhered to one another using a lamination and/or calendering process. After adhering the siloxane membrane and the air electrode, the transfer layer can be removed relatively easily as the adhesive forces between the air electrode and the siloxane membrane are strong. According to other exemplary embodiments, the siloxane membrane and the air electrode may be coupled/adhered to one another by any number of processes utilizing heat and/or pressure.

According to an exemplary embodiment, the siloxane membrane is co-extruded onto a transfer layer. One or more layers of the air electrode (e.g., the active layer, the gas diffusion layer, all layers of the air electrode, etc.) are then deposited onto the siloxane membrane. After deposition of the one or more layers of the air electrode, a lamination and/or calendering process may used to reduce the thickness. While multi-layer co-extrusion processes have been described above, the extrusion process may be a single layer extrusion process. Further, the multi-layer co-extrusion processes may include more than two co-extruded component layers, materials, etc.

According to another exemplary embodiment, the siloxane membrane is deposited onto a transfer layer. The deposition process may include, but is not limited to, casting (solvent or aqueous), spraying (solvent or aqueous), contact printing (e.g., screen stencil, flexography, gravure, off-set, etc.), non-contact printing (e.g., inkjet), spin-coating, and chemical vapor deposition. This deposition process may then be followed by a process utilizing heat and/or pressure (e.g., laminating, calendering, etc.) to remove pinholes, flatten the structure, and/or achieve a desired thickness of the siloxane membrane. The siloxane membrane, once deposited on the transfer membrane, may then be coupled or adhered to the air electrode (e.g., by a calendering and/or lamination process).

According to another exemplary embodiment, the siloxane membrane is deposited directly onto the air electrode. The deposition process may include, but is not limited to, casting (solvent or aqueous), spraying (solvent or aqueous), contact printing (e.g., screen stencil, flexography, gravure, off-set, etc.), non-contact printing (e.g., inkjet), spin-coating, and chemical vapor deposition. This deposition process may then be followed by a process utilizing heat and/or pressure (e.g., laminating, calendering, etc.) to remove pinholes, flatten the structure, and/or achieve a desired thickness of the siloxane membrane and/or the air electrode.

According to other exemplary embodiments, the siloxane membrane is coupled or adhered to the housing of the metal-air battery. The siloxane membrane may be coupled or adhered to the interior or the exterior of the case. The siloxane membrane may or may not be further adhered to the air electrode. According to some exemplary embodiments, a process involving heat and/or pressure (e.g., laminating, calendering, etc.) may be used to couple or adhere the siloxane membrane to the housing. According to other exemplary embodiments, a deposition process may be used to adhere the siloxane membrane to the housing. The deposition process may include, but is not limited to, casting (solvent or aqueous), spraying (solvent or aqueous), contact printing (e.g., screen stencil, flexography, gravure, off-set, etc.), non-contact printing (e.g., inkjet), spin-coating, and chemical vapor deposition.

According to an exemplary embodiment, an overmolding process may be used. According to one exemplary embodiment, the siloxane membrane may be overmolded by a material (e.g., a porous material) that forms the housing. According to other exemplary embodiments, other variations on an overmolding process may be used.

According to still other exemplary embodiments, any process sufficient to couple or adhere the siloxane membrane (or a selective membrane of a material or materials other than siloxane) to the air electrode and/or the housing of the metal-air battery may be used. None of these processes require the use of a support layer. Further, at one or more times during any of these exemplary processes, a process utilizing heat and/or pressure may be included to remove pinholes, flatten the structure, achieve a desired thickness of the siloxane membrane and/or the air electrode, and/or to achieve other desired characteristics for the siloxane membrane and/or the air electrode. For example, a heat/radiation source (e.g., ultraviolet radiation source, an infrared radiation source, etc.) may be used to cure the siloxane membrane to the air electrode, inducing cross-linking therebetween and/or causing polymer ‘breakdown” to modify transport properties. In a further example, a heat source (e.g., a ultraviolet radiation source) is provided to cure the siloxane membrane to the air electrode. The siloxane membrane and air electrode are then washed to remove non-patterned (cured) areas.

Although the battery 10 has been described as being provided in the form of a coin or button cell, it should be noted that siloxane membranes may be utilized in conjunction with batteries of other configurations as well (e.g., prismatic cells, cylindrical cells, oval cells, flow cells, fuels cells, etc.). According to an exemplary embodiment, the placement of the siloxane membrane in batteries of different configurations may be similar to that used for coin cells (e.g., placed between the cell housing and the air electrode, coupled to the exterior surface of the housing, or other configurations or placements as described herein, etc.).

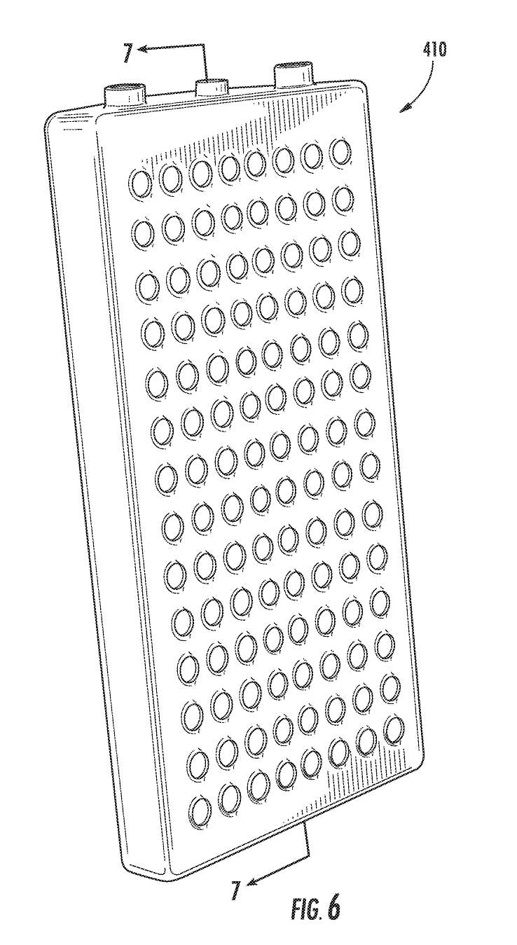

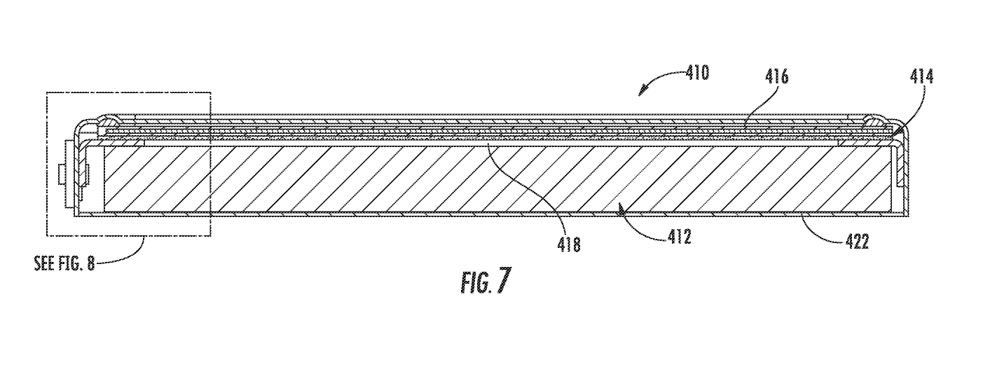

Referring to FIGS. 6-8, a prismatic metal-air (e.g., zinc-air) battery 410 is shown according to an exemplary embodiment. FIG. 7 shows a cross-sectional view of the battery 410, and FIG. 8 shows a detail view of one end of the battery 410 taken across line 8-8 in FIG. 7. The battery 410 includes a housing 422, a metal electrode 412 running along the length of the cell, an air electrode 414, and an electrolyte 418 provided in the space between the metal electrode 412 and the air electrode 414. The electrolyte 418 also resides inside the pores of the metal electrode 412 and partly inside the pores of the air electrode 414. A siloxane membrane 416 (similar to that described with respect to the siloxane membrane 16 for the coin cell embodiment described above) is provided on top of/adjacent to the air electrode 414. The siloxane membrane 416 has a thickness greater than 0.1 μm and provides for improved humidity and CO₂ management for the battery, while still providing for a desired rate of oxygen diffusion. The upper portion of the housing 422 contains holes 426 (e.g., slots, apertures, etc.) for air to enter the battery 410.

The air electrode 414 and siloxane membrane 416 may be secured (e.g., by gluing) to the lid of the housing to prevent leakage. The gas diffusion layer side of the air electrode faces the holes 426 in the battery housing 422, and the siloxane membrane 416 is positioned substantially between the gas diffusion layer and the holes 426 in the housing 422. The battery 410 is filled with a metal (e.g., zinc) paste. Current collectors for the air electrode and the metal electrode may be attached using contact pins by resistance welding, laser welding, or other methods known in the art and shielded (e.g., with glue) to prevent gassing in the cell. The housing is then closed off (other than the air holes) (e.g., by ultrasonic welding).

The battery 410 provides for a commercially viable prismatic battery that may be used in numerous applications wherein prismatic batteries are or may be used because battery 410 provides, in addition to a high current density, a lifetime in that is sufficient and/or desirable for these applications (e.g., cell phones, cameras, MP3 players, portable electronic devices, etc.).

Siloxane membranes may also be used in flow batteries such as those described in International Application PCT/US10/40445 and corresponding U.S. patent application Ser. No. 12/826,383, filed Jun. 29, 2010, each filed Jun. 29, 2010, the entire disclosures of which are incorporated herein by reference. FIG. 9 illustrates an exemplary embodiment of a flow battery 510.

Referring to FIG. 9, a metal-air flow battery shown as a zinc-air flow battery 510 including a siloxane membrane 516 is shown according to an exemplary embodiment. The term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

The zinc-air flow battery 510 is shown as a closed loop system including a zinc electrode 512, an electrolyte 518, one or more storage devices shown as tank or chamber 544, and a reactor 546 having one or more reaction tubes 548, each including an air electrode 514.

The zinc electrode 512 is combined with the electrolyte 518 to form a zinc paste 550, which serves as a reactant for the zinc-air flow battery 510, according to an exemplary embodiment. The reactant (e.g., active material, etc.) is configured to be transported (e.g., fed, pumped, pushed, forced, etc.) into and out of the reactor 546. When the zinc-air flow battery 510 is discharging, the zinc paste 550 is transported into the reactor 546 and through the reaction tubes 548 and a zinc oxide paste 552 is transported out of the reactor 546 after the zinc paste 550 reacts with the hydroxyl ions produced when the air electrode 514 reacts with oxygen from the air. When the zinc-air flow battery 510 is charging, the zinc oxide paste 552 is transported into the reactor 546 and through the reaction tubes 548 and the zinc paste 550 is transported out of the reactor 546 after the hydroxyl ions are converted back to oxygen. The pastes 550, 552 are stored in the tank 544 before and after being transported through the reactor 546, the zinc paste 550 being stored in a first cavity 554 of the tank 544 and the zinc oxide paste 552 being stored in a second cavity 556 of the tank 544.

As discussed above, the reaction tubes 546 each include an air electrode 514 disposed between at least two protective layers. FIG. 9 illustrates one of the reaction tubes 548 of the zinc-air flow battery 510 in more detail, exploded from the zinc-air flow battery 510 according to an exemplary embodiment. The reaction tube 548 is shown having a layered configuration that includes an inner tube or base 558, a separator 560, the air electrode 514, and an outer tube or protective casing 562 according to an exemplary embodiment. The base 558 is shown as the innermost layer of the reaction tube 546, the protective casing 562 is shown as the outmost layer of the reaction tube 546, and the other layers are shown disposed substantially between and concentric with the base 558 and the protective casing 562.

According to the exemplary embodiment shown, the composition of air electrodes 514 enables production of tubular air electrodes according to an exemplary embodiment. The air electrode 514 includes a plurality of binders 564. The binders 564 provide for increased mechanical strength of the air electrode 514, while providing for maintenance of relatively high diffusion rates of oxygen (e.g., comparable to more traditional air electrodes). The binders 564 may provide sufficient mechanical strength to enable the air electrode 514 to be formed in a number of manners, including, but not limited to, one or a combination of extrusion, stamping, pressing, utilizing hot plates, calendaring, etc. This improved mechanical strength may also enable air electrode 514 to be formed into any of a variety of shapes (e.g., tubular, etc.).

The tubular configuration of the reaction tubes 546, and, correspondingly, the air electrodes 514, makes the air electrodes 514 relatively easy to assembly without leakage. The tubular configuration in conjunction with the conductive gas diffusion layer permits for the current collectors for the air electrodes 514 to be on the outside of the reaction tubes 546, substantially preventing any leakage from the air electrode current collector. Further, the tubular configuration permits for the current collectors for zinc electrodes 512 to be integrated substantially within reaction tubes 546, eliminating contact pin leakage.

In addition, the tubular configuration of air electrodes a 514 provides improved resistance to pressure, erosion (e.g., during transport of zinc paste 550 and zinc oxide paste 552, etc.), and flooding. For example, the tubular configuration of the air electrode permits zinc paste to flow through a passage 560 defined thereby with less friction than if the air electrode were configured as a flat plate, causing relatively less erosion therewithin. Also, the cylindrical reaction tubes 546 having a layered configuration permits for incorporation of elements/layers providing mechanical stability and helping to provide improved pressure resistance.

The siloxane membrane 516 is shown disposed to the exterior of a gas diffusion layer 530 and an active layer 532 of the air electrode 514 in the reaction tube 546 according to an exemplary embodiment. By including the siloxane membrane 516 in the zinc-air flow battery 510, less electrolyte 518 is needed in the tank 522 to accommodate the water loss attendant with its operation (e.g., as a result of vaporization, etc.). Further, by reducing the negative effects of CO₂ on the zinc-air flow battery 510, the siloxane membrane 516 reduces the need for peripherals and maintenance (e.g., CO₂ scrubbers, etc.). According to other exemplary embodiments, the air electrode and the siloxane membrane may be otherwise configured. For example, the siloxane membrane may replace the gas diffusion layer or be positioned exterior to the protective casing 562. According to still other exemplary embodiments, siloxane may be incorporated into the reaction tube other than in the form of a membrane. For example, siloxane material may be incorporated into one or more layers of the air electrode.

According to an exemplary embodiment, the siloxane membrane 516 of the metal-air flow battery 510 may be extruded to be tubular and then calendered onto the gas diffusion layer 530 of the air electrode 514. According to one exemplary embodiment, the siloxane membrane may be extruded into a flat sheet that is disposed or wrapped about the air electrode and then adhered (e.g., by laminating or calendering) thereto. According to some exemplary embodiments, the siloxane membrane may be formed and adhered or coupled to the air electrode and/or housing of a flow cell via any one or combination of the processes described above with reference to the siloxane membrane 516.

Operation of zinc-air flow battery 510 during discharge will be discussed according to an exemplary embodiment.

During discharge, the zinc paste 550 is fed from the first cavity 554 through a zinc inlet/outlet and distributed amongst the reaction tubes 546 by a feed system 572. According to the exemplary embodiment shown, the feed system 572 includes a plurality of archimedean screws 574. The screws 574 rotate in a first direction, transporting the zinc paste 550 from proximate the first end portion 576 toward the second end portion 578 of each reaction tube 546. An air flow 580 is directed by an air flow system 582, shown including fans 584, through a plurality of air flow channels 586 defined between the reaction tubes 546. The air flow 580 is at least partially received in the reaction tubes 546 through a plurality of openings 588 in the protective casing 562 and toward the passage 566, as shown by a plurality of air flow paths 590. Oxygen from the air flow 580 is converted to hydroxyl ions in the air electrode 514; this reaction generally involves a reduction of oxygen and consumption of electrons to produce the hydroxyl ions. The hydroxyl ions then migrate toward the zinc electrode 512 in the zinc paste 550 within the passages 566 of the reaction tubes 546. The hydroxyl ions cause the zinc to oxidize, liberating electrons and providing power.

As a result of its interaction with the hydroxyl ions, the zinc paste 550 is converted to the zinc oxide paste 552 within the reaction tubes 546 and releases electrons. As the screws 574 continue to rotate in the first direction, the zinc oxide paste 552 continues to be transported toward the second end portion 578. The zinc oxide paste 552 is eventually transported from reaction tubes 546 through a zinc oxide inlet/outlet and deposited in the second cavity 556 of the tank 544.

Operation of zinc-air flow battery 510 during charging will be discussed according to an exemplary embodiment.

As discussed above, the zinc-air flow battery 510 is rechargeable. During charging, the zinc oxide paste 552 is converted or regenerated back to zinc paste 550. The zinc oxide paste 552 is fed from the second cavity 556 and distributed amongst the reaction tubes 546 by the feed system 572. The screws 574 rotate in the second direction (i.e., opposite to the direction they rotate during discharging), transporting the zinc oxide paste 552 from proximate the second end portion 578 toward the first end portion 576 of each reaction tube 546. The zinc oxide paste 552 is reduced to form the zinc paste 550 as electrons are consumed and stored. Hydroxyl ions are converted to oxygen in the air electrodes 514, adding oxygen to the air flow 580. This oxygen flows from the reaction tubes 546 through the openings 588 in the protective casing 562 outward from proximate the passage 566, as shown by the air flow paths 590.

Existing metal-air batteries that do not utilize a siloxane membrane are limited by environmental conditions (e.g., the presence of CO₂, humidity, etc.), which limit the battery life and performance (e.g., standby lifetime). Metal-air coin or button cells are currently the only metal-air batteries that are commercially available/utilized in a large volumes. Most commonly, these metal-air batteries are used in hearing aids. These batteries have a relatively long shelf life due to closed air access packaging, but dry out within relatively quickly (e.g., approximately within five weeks of removing the tape covering the holes in the housing of the metal-air coin cell) because, when in use, the surrounding environmental conditions cause a slow capacity loss of the metal-air coin cell batteries. Due to these constraints, only a small part of the coin cell size battery market is available for these batteries. For the existing coin metal-air batteries, current densities of up to 20-25 mA and cut off voltages of 1-1.1V for 675 size metal-air coin cell are typically sufficient for the hearing aid. Also, an energy density of 1400 Wh/l can be shown for existing coin metal-air batteries. Coin cells for other electronic devices are based on Ag/Zn, MnO2/Zn, or lithium cannot match the energy density of metal-air (e.g., zinc-air) batteries.

Experimental data will now be presented illustrating the operation, functionality, and CO₂ management benefits provided by a siloxane membrane, e.g., siloxane membrane 16, and/or siloxane additives (e.g., in the gas diffusion layer or active layer of the air electrode).

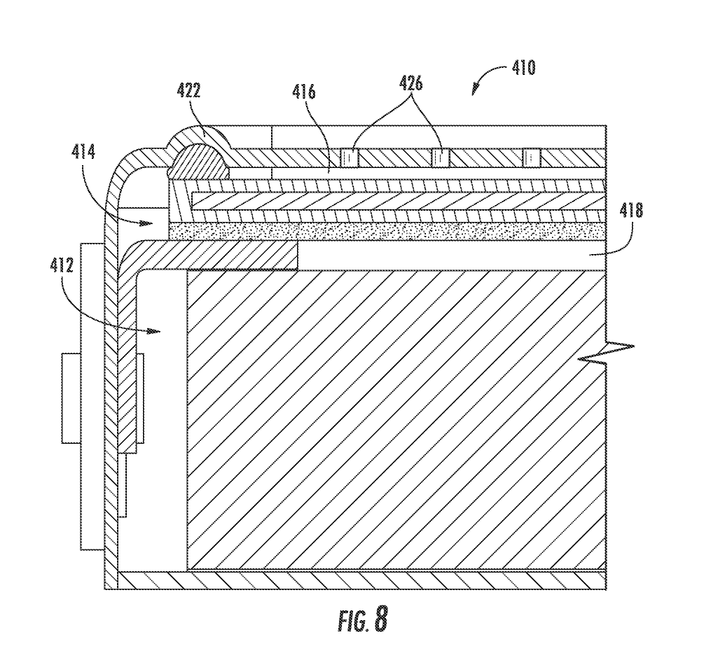

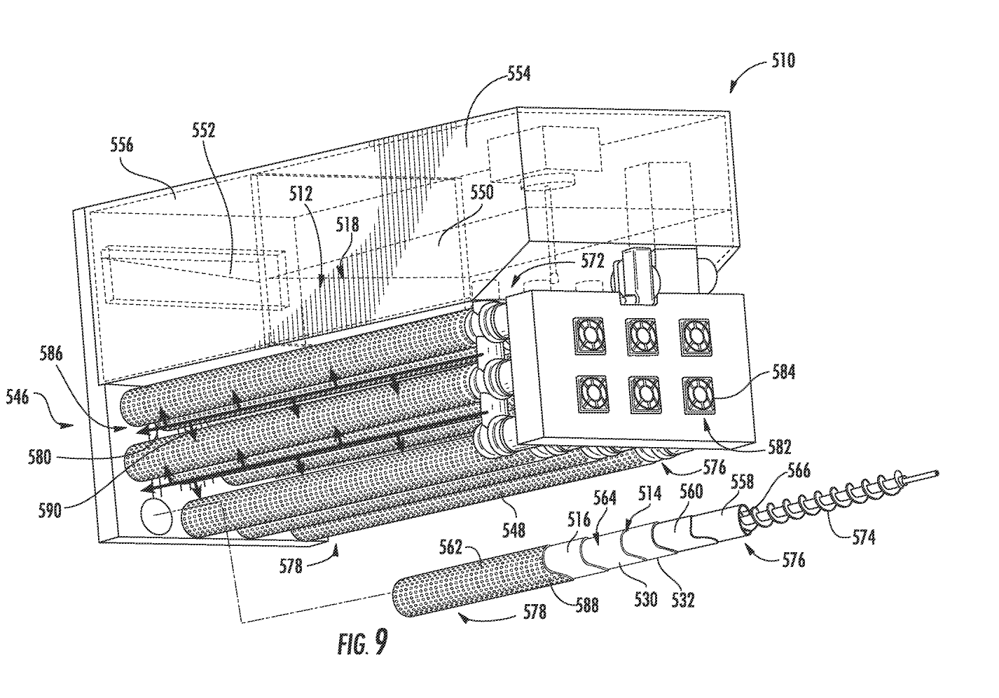

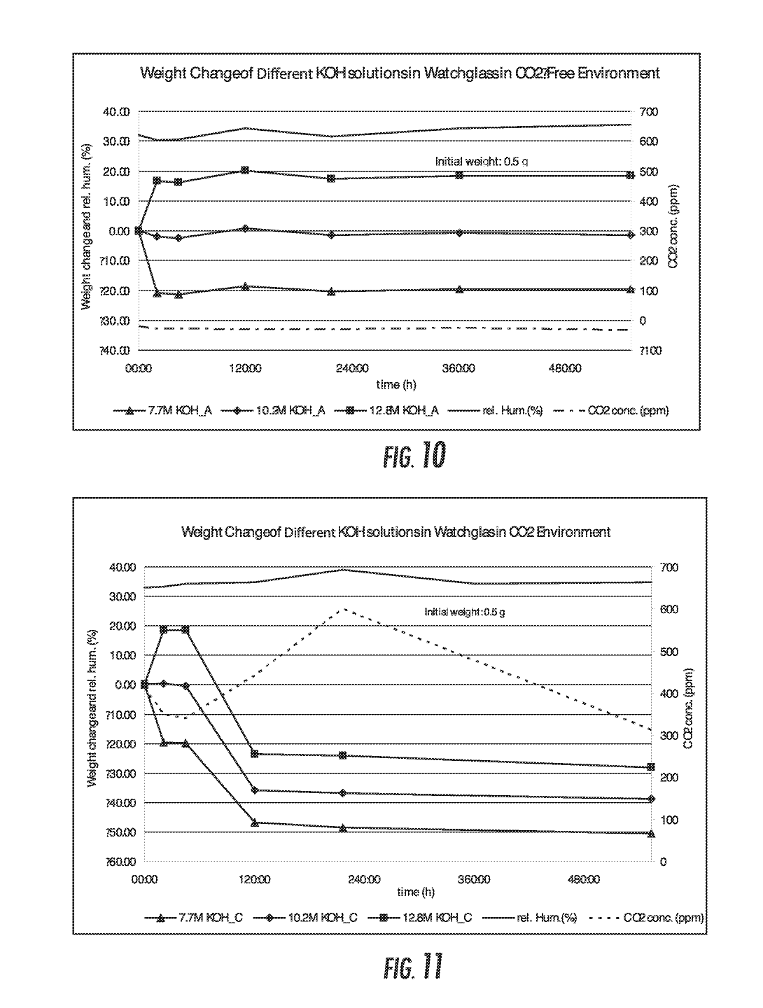

FIGS. 10-13 are graphs illustrating the effect that CO₂ has on the tendency for an electrolyte to dry out, and illustrate the percentage weight change for an electrolyte over time. It is known that potassium hydroxide (KOH), which is one possible material used for the metal-air battery electrolyte, is hygroscopic. Theoretically, KOH should not dry out above a certain relative humidity.

FIGS. 10 and 11 illustrate the effects of CO₂ absorption on the percentage weight change of a KOH electrolyte over time in an environment having approximately 35 percent relative humidity. Various KOH/water solutions (7.7M, 10.2M, and 12.8M) were provided in a watchglass in a CO₂-free environment (FIG. 3) and in a CO₂-containing environment, and the percentage weight change of the electrolyte over time was monitored. As can be seen in FIG. 10, in the CO₂-free environment, the various KOH solutions first adjusted to the relative humidity of the surroundings by taking up or losing water, according to their concentration, and then their weight remained substantially constant/stable thereafter (the weight of the 12 M KOH solution did not initially adjust to a significant degree because it was already in equilibrium with the relative humidity of 35 percent). In contrast, as shown in FIG. 11, where the KOH solutions were provided in a CO₂-containing environment, these KOH solutions continued to decrease in weight even after the time when the KOH solutions in the CO₂-free environment stabilized, illustrating that in a CO₂-containing environment, the KOH solutions would tend to dry out.

These solutions eventually at least partially crystallized to form K₂CO₃ crystals. This crystallization occurs substantially because CO₂ undergoes carbonation, because of the presence of atmospheric CO₂. Carbonation substantially causes the evaporation of the water in the KOH electrolyte. The resulting K₂CO₃ crystals have substantially no hygroscopic property, unlike the original KOH.

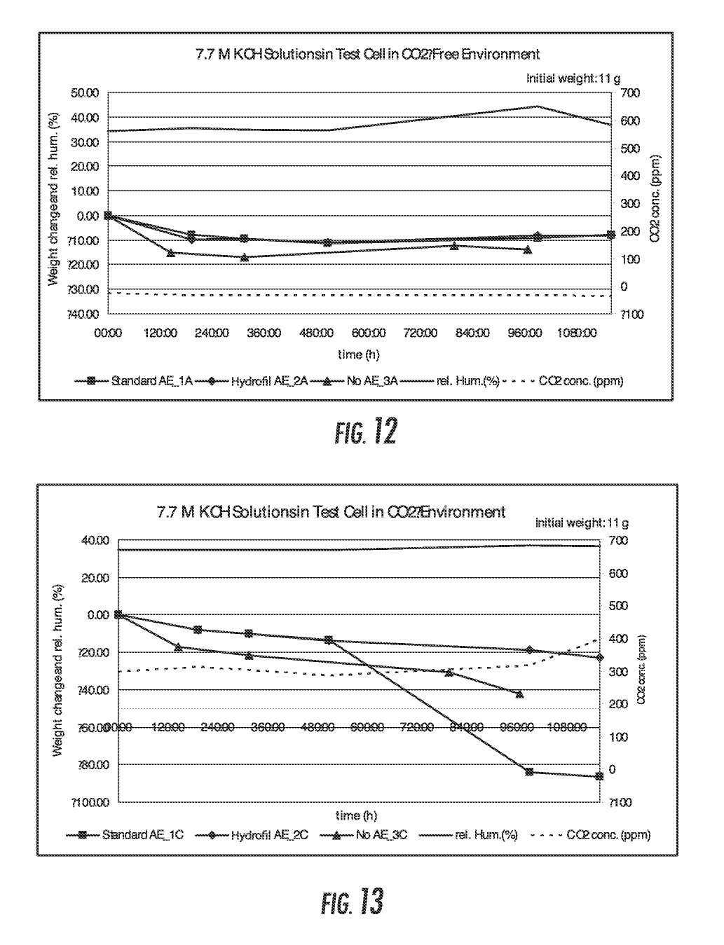

FIGS. 12 and 13 illustrate substantially the same behavior as shown in FIGS. 10 and 11, with the difference being that the results shown in FIGS. 12 and 13 were obtained using prismatic cell prototypes having an air electrode but no metal electrode (instead of using a watchglass as in FIGS. 10 and 11). Test cells were prepared using various types of air electrodes, with the concentration of the KOH electrolyte being 7.7 M. Again, the KOH solutions in the CO₂-containing environment tended to dry out over time, as evidenced by the downward sloping lines indicative of continued weight loss in the electrolyte as shown in the FIG. 13 graph.

The results described with respect to FIGS. 10-13 indicate KOH continues to dry out in a CO₂-containing environment over time (exhibited by the continued weight loss with time, which is attributable to water loss), and that when the KOH is instead placed in a CO₂-free environment, the weight of the electrolyte remains substantially constant over time (indicating that the electrolyte does not dry out). This highlights the importance of preventing CO₂ entry into a metal-air battery, and demonstrates that a membrane (such as siloxane membrane 16) that selectively allows oxygen transport while preventing CO₂ transport may provide significant lifespan-extending benefits for a metal-air battery.

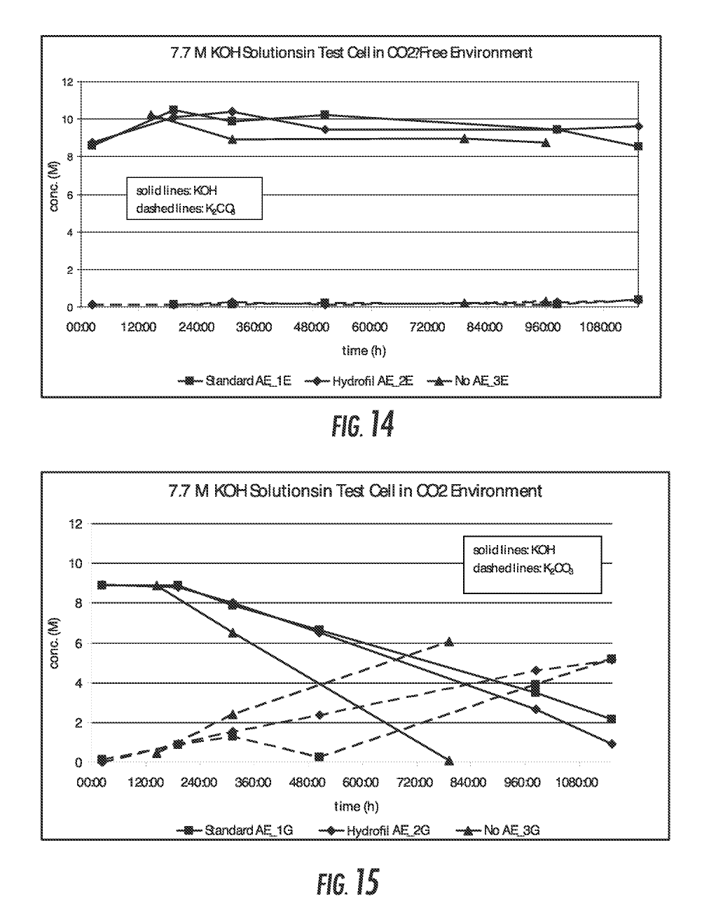

FIGS. 14 and 15 are graphs illustrating the results of an experiment intended to examine the effects of CO₂ on the concentration of hydroxides in a prismatic prototype metal-air battery over time. The results indicate that the hydroxide concentration is reduced by the presence of CO₂. In the CO₂-free environment, FIG. 14 shows that the concentrations of hydroxides remained relatively constant over time, whereas in the CO₂-containing environment, FIG. 15 shows a dramatic reduction in hydroxide concentration with time. As noted by FIGS. 14 and 15, in the CO₂-free environment, the concentration of K₂CO₃ remains relatively constant at a very low value, while in the presence of CO₂, the K₂CO₃ increases with increasing time.

Hydroxide concentration also affects the capacity of the metal-air battery anode. With decreasing hydroxide concentration, the capacity of the battery tends to decrease. Accordingly, CO₂ can both dry out the metal-air battery and decrease the capacity of a metal-air battery by decreasing the concentration of hydroxides in the metal-air battery. This again illustrates the importance of preventing CO₂ from entering the battery.

Prior to the investigation by applicants, it does not appear that the available technical literature has described the mechanism for the water loss in zinc-air batteries as a function of temperature, relative humidity, and CO₂ concentration in air. As illustrated by the experiments described above, little or no water loss was observed for KOH solutions when exposed to air with no or low CO₂ gas concentrations. However, the rate of water loss is significantly higher when exposed to air with relatively higher CO₂ gas concentration. Without wishing to be bound to any particular theory, the Applicants believe that this water loss is experienced because KOH undergoes carbonation, which is caused by CO₂, as described by the following formula:

KOH+CO₂←→K₂CO₃

and that the following mechanism may describe the phenomena of dry out and flooding of metal-air (e.g., zinc-air) batteries: CO₂ (g) is converted to CO₂ (aq), followed by the conversion of CO₂ (aq) to CO₃²⁻ (aq) due to the high OH⁻ concentration (the reaction consumes 2 OH⁻). The OH⁻ concentration then drops, and with the reduction in OH⁻ concentration, the partial pressure of water vapor increases as the K₂CO₃ (aq) has low hygroscopic properties. With increased concentration due to water loss, and when the solubility product is reached, precipitation of K₂CO₃(s) may be observed. Because KOH is hygroscopic and K₂CO₃ has low hygroscopic properties, as KOH is converted to K₂CO₃ in the presence of CO₂, the stability of the battery is compromised (e.g., it dries out, shortening its lifespan).

It should be noted that, while KOH (and other hydroxide solutions) were known to be hygroscopic, the above-discussed test results and this mechanism show empirically that KOH tends to dry out in the presence of CO₂, which does not appear to have been established before the inventors' efforts. As a result of this understanding, materials that reduce the transport rate of CO₂ and have selectivity for O₂ versus water vapor (such as the siloxane membrane 16) would appear to be good candidates for improving the lifetime of metal-air batteries.

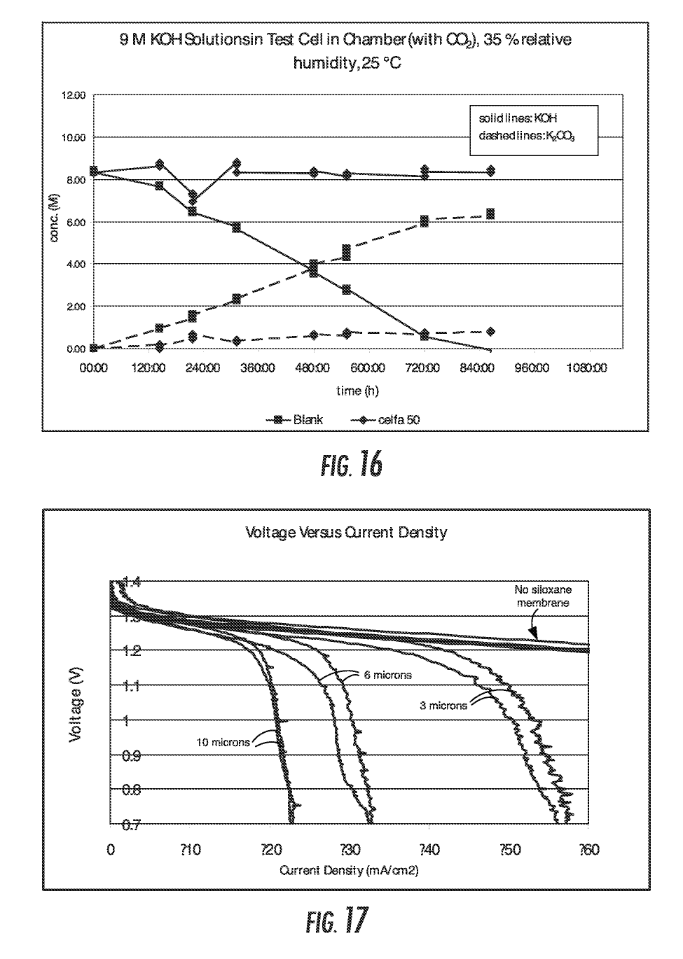

FIG. 16 is a graph illustrating the benefit that a siloxane membrane may have to mitigate against the adverse effects of CO₂ described above. Prismatic metal-air battery prototypes (not including metal electrodes) were prepared, with some of the prototypes including a 50 μm thick siloxane membrane (using siloxane from Celfa) disposed on a gas diffusion layer of an air electrode (the other prototypes were prepared without the siloxane membranes, and are denoted as “blanks” in the data). A 9 M KOH electrolyte solution was used for the cells.

The sample sells were monitored over time while being exposed to CO₂ at a relative humidity of 35%, and a temperature of 25° C. The prismatic prototype metal-air batteries that included the siloxane membrane experienced only a slight reduction in hydroxide concentration after more than 800 hours, while those prototypes that did not include a siloxane membrane exhibited a drop in the hydroxide concentration to less than 1M during the same time frame (during which time the concentration of K₂CO₃ increased). Generally, slowing CO₂ intake to a metal-air battery helps keep the hydroxide concentration stable and reduces the tendency to form K₂CO₃. Accordingly, the significant improvement in the hydroxide concentration with the use of the siloxane membrane illustrated in the results shown in FIG. 16 indicates that the siloxane membrane slows CO₂ transport into the metal-air batteries. By providing for a more stable hydroxide concentration, the siloxane membrane helps slow the drying out of a metal-air battery. These results are also significant because they illustrate that batteries without a siloxane film are clearly influenced by the environment.

The data shown in FIG. 16 further illustrate that the carbonization of the electrolyte and water loss are linked. The data suggests that the range of stability of the KOH against water is surprisingly far larger that earlier assumed (e.g., less than 45% relative humidity for dry out). With the formation of carbonates in the electrolyte, the hydroscopic properties of the KOH is lost and dry out occurs. Accordingly, it appears that the dry out rate reported in prior art is at least partially due to the CO₂ effect.

FIG. 17 illustrates data examining the relationship between siloxane membrane thickness and the oxygen diffusion limit for test cells. Prototype metal-air batteries were manufactured which incorporated siloxane membranes of various thicknesses (3, 6, and 10 microns) and the current density was monitored during discharged and compared to prototype batteries that did not utilize a siloxane membrane. All experiments were performed in a half cell setup with a 7 M KOH electrolyte at 25° C. The exposed air electrode surface was 3 cm². The siloxane films were placed onto a porous polypropylene support material in a separate layer and placed on top of the gas diffusion layer facing the air side. The siloxane films were co-extruded with a support material as described above, and the support material was removed as the siloxane films were transported onto the porous support material, as described above.

As shown in FIG. 17, the thinner the siloxane membrane, the higher the oxygen diffusion limit for the prototype cells. Cells that did not have a siloxane membrane showed a higher oxygen diffusion limit, since there was no siloxane present to limit the amount of oxygen entering the cell. As described above, however, cells without a siloxane membrane would be expected to have a significantly more limited lifespan than those with a siloxane membrane due to the effects of humidity and CO₂ on the components of the cell. In designing a cell for a given application, then, it would be expected that there would be a tradeoff between the operating current range for a cell and the lifetime of the cell. The battery designer would have the option of choosing a siloxane membrane having a thickness that allows for the cell to operate in a suitable current range while providing the advantages that come from using siloxane (e.g., improved humidity and CO₂ management for the cell).

According to an exemplary embodiment, instead of using a membrane containing siloxane, the air electrode may be coated with a siloxane solution (either by dipping a prepared air electrode into a siloxane solution or by applying a siloxane solution to the exterior of all or a portion of the air electrode using other means) to impregnate the air electrode with siloxane.

To test the efficacy of the siloxane material, an air electrode was coated with a siloxane material using a dipping process. Following preparation of the air electrode, the electrode was immersed in a siloxane solution (e.g., 5.8% siloxane in isopropanol) for a relatively short period of time (in this case, approximately one second, although coating times may differ according to other exemplary embodiments) to coat the air electrode.

The air electrode was then placed in a vacuum chamber for approximately ten minutes to remove any air entrapped in the air electrode structure and to force the siloxane into the pores of the air electrode. After the vacuum treatment, excess solution was removed from the air electrode using a paper towel (according to other exemplary embodiments, air drying or other suitable methods may be employed). The air electrode was then dried in an oven (e.g., at 70° C. for a period of 15 hours, although the temperature and time may differ according to other exemplary embodiments). During the oven drying step, the gas diffusion layer was positioned facing upward, and a thin film will be visible on the gas diffusion layer after drying is complete.

To evaluate the effect of the siloxane, a non-treated air electrode (i.e., one that was not coated with a siloxane solution) was used as a blank. The blank was prepared in the same batch as the siloxane-treated air electrode. The experiment was repeated several times. It was surprisingly discovered that the initial charge and discharge profile was superior for the air electrodes that were dip coated in a siloxane solution as compared to the air electrodes that were not dip coated in a siloxane solution. This is illustrated, for example, in FIG. 18, which shows initial charge and discharge curves at 20 mA/cm² for cells having 6 M KOH electrolytes that incorporate either the treated or untreated air electrodes. For the non-treated air electrodes (dotted line), the voltage during charge and discharge took time to normalize (e.g., approximately 120 hours), as illustrated, for example, by the fact that the charging portion of the curve was above the 2.0 volt level and gradually decreased with each charge cycle until it normalized around 2.0 volts. In contrast, the treated air electrodes (grey lines) cycled around a voltage range consistently throughout the testing, and did not require time to normalize to the 2.0 volt level.

These results suggest that by treating an air electrode with a siloxane solution, one may reduce or eliminate the need to perform an initial battery formation operation to normalize the charge and discharge behavior of the air electrode (e.g., to activate the air electrode). Battery formation operations are typically performed to ensure that the battery exhibits regular and predictable charge and discharge cycling. If such battery formation operations were not performed with untreated air electrodes, it would be more difficult to create accurate battery charging/discharging algorithms, since the response of the battery would be unknown until the battery normalized. By using a siloxane solution to coat all or a portion of the air electrode, the battery formation process may be eliminated, which in turn may reduce the time and cost of manufacturing air electrodes and metal-air batteries (e.g., if the need to perform an initial set of charge/discharge cycles is eliminated, lengthy initial charge and discharge operations can be eliminated from the manufacturing process, saving both time and resources).

In another experiment, the siloxane solution was applied only onto the gas diffusion side of a first air electrode and onto the active layer side of another air electrode (e.g., by brushing the solution onto the respective layers). The sample with siloxane on the gas diffusion side did not show any significant difference from the untreated sample relating to the electrochemical performance during charge and discharge. The sample treated on the active layer side of the air electrode, however, showed similar performance improvements as for the air electrode fully immersed into the siloxane solution. This shows that the treatment of the active layer with a siloxane solution can help in improving the initial charge/discharge profile of the air electrode, whereas coating the gas diffusion side may not provide any significant advantage to improving the activation of the battery (although it may have other benefits, such as providing a second barrier against water and CO₂ transport; further, it should be noted that it may be desirable in some circumstances to use a dip coating process during manufacturing instead of a process in which only one side is brushed or coated with a solution).

In order to validate that it was the siloxane and not the solvent in the siloxane solution that caused this improvement in the activity, an air electrode sample was dip coated into a pure solvent without any dissolved siloxane included therein. This air electrode sample exhibited similar electrochemical performance as the untreated sample, suggesting that the solvent plays no role in the improved initial charge/discharge performance of air electrodes coated with a siloxane solution.

The inventors of the present application have thus unexpectedly found that in addition to the advantages associated with siloxane relating to the prevention of water and CO₂ from entering the cell (as described above with respect to the use of siloxane membranes, but similarly applicable to air electrodes coated with a siloxane solution), siloxane applied in a dipping process also has the advantageous benefit of improving the activation of the air electrode. This differs from the conventional wisdom relating to battery formation, where it was believed that activation of the battery required a slow wet up of the active layer during an extended battery formation charge/discharge cycling process.

In an exemplary embodiment, various combinations of materials, structures, application methods, methods of manufacture, and applications discussed herein may be used within the scope of this disclosure. Also, while the description included herein is primarily directed to batteries, the concepts disclosed also apply to fuels cells and other electrochemical conversion devices having desired configurations.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present inventions.

What is claimed is:

1. A metal-air battery, comprising:
an air electrode; and
a siloxane material proximate to or incorporated within the air electrode.

2. The metal-air battery of claim 1, wherein the siloxane material is configured to reduce the transport of carbon dioxide into the metal-air battery.

3. The metal-air battery of claim 1, wherein the siloxane material is provided as a siloxane membrane.

4. The metal-air battery of claim 3, wherein the metal-air battery further comprises a housing having at least one hole provided therein, and wherein the siloxane membrane is located between the air electrode and the housing adjacent the at least one hole.

5. The metal-air battery of claim 3, wherein the metal-air battery further comprises a housing having at least one hole provided therein, and wherein the siloxane membrane is located adjacent the hole on an outer surface of the housing.

6. The metal-air battery of claim 3, wherein the air electrode includes an active layer and a gas diffusion layer, and wherein the siloxane membrane is coupled to a first side of the gas diffusion layer.

7. The metal-air battery of claim 3, wherein the air electrode includes an active layer and the siloxane membrane is used in lieu of a gas diffusion layer.

8. The metal-air battery of claim 3, wherein the siloxane membrane has a thickness of between approximately 3 and 50 μm.

9. The metal-air battery of claim 3, wherein the siloxane membrane comprises a conductive additive.

10. The metal-air battery of claim 3, wherein the siloxane membrane is utilized in place of the current collector for the air electrode.

11. The metal-air battery of claim 1, wherein the siloxane material is provided as a coating on at least one surface of the air electrode.

12. The metal-air battery of claim 1, wherein the air electrode comprises an active layer and a gas diffusion layer, and wherein the siloxane material is incorporated within the gas diffusion layer.

13. The metal-air battery of claim 1, wherein the metal-air battery is a flow battery and the air electrode has a generally tubular configuration, and wherein the siloxane material is provided as a membrane having a generally tubular shape that is provided adjacent to the air electrode.

14. A metal-air battery comprising:
a metal electrode;
an electrolyte;
an air electrode;
a siloxane membrane proximate to or incorporated within the air electrode; and
a housing.

15. The metal-air battery of claim 14, wherein the siloxane material is configured to reduce the transport of carbon dioxide into the metal-air battery.

16. The metal-air battery of claim 14, wherein the housing has at least one hole provided therein, and wherein the siloxane membrane is located between the air electrode and the housing adjacent the at least one hole.

17. The metal-air battery of claim 14, wherein the housing has at least one hole provided therein, and wherein the siloxane membrane is located adjacent the hole on an outer surface of the housing.

18. The metal-air battery of claim 14, wherein the air electrode includes an active layer and a gas diffusion layer, and wherein the siloxane membrane is coupled to a first side of the gas diffusion layer.

19. The metal-air battery of claim 14, wherein the air electrode includes an active layer and the siloxane membrane is used in lieu of a gas diffusion layer.

20. The metal-air battery of claim 14, wherein the siloxane membrane has a thickness of between approximately 3 and 50 μm.

21. The metal-air battery of claim 14, wherein the siloxane membrane comprises a conductive additive.

22. The metal-air battery of claim 14, wherein the siloxane membrane is utilized in place of the current collector for the air electrode.

23. The metal-air battery of claim 14, wherein the metal-air battery is a flow battery and the air electrode has a generally tubular configuration, and wherein the siloxane membrane has a generally tubular shape and is provided adjacent to the air electrode.

24. A membrane for a metal-air battery comprising a siloxane material configured to reduce the transport of carbon dioxide therethrough.

25. The membrane of claim 24, wherein the membrane further comprises a conductive additive.

26. The membrane of claim 24, wherein the siloxane material includes a reaction product of a silicone resin and one or more silicone fluids.

27. The membrane of claim 24, wherein the membrane is positioned proximate to an air electrode.

28. The membrane of claim 24, wherein the siloxane membrane is coupled to a first side of a gas diffusion layer of an air electrode, and wherein the air electrode further includes an active layer.

29. The membrane of claim 24, wherein the membrane is positioned adjacent to an outer surface of a metal-air battery housing, and wherein the outer surface includes one or more holes therein.

30. The membrane of claim 24, wherein the membrane is positioned between an air electrode and a metal-air battery housing.

31. The membrane of claim 24, wherein the membrane has a thickness of between approximately 3 and 50 μm.
